(19) United States
(12) Patent Application Publication
(10) Pub. No.: US 2004/0225559 A1
(43) Pub. Date: Nov. 11, 2004

(54) Sponsored data organizer

(76) Inventor: Sheldron Seplowitz, Stamford, CT (US)

Correspondence Address: ST. ONGE STEWARD JOHNSTON & REENS, LLC, 986 BEDFORD STREET, STAMFORD, CT, 06905-5619, US

(21) Appl. No.: 10/429,475

(22) Filed: May 5, 2003

(51) Int. Cl. G06F 17/60

(52) U.S. Cl. 705/14

(57) ABSTRACT

A system to facilitate the access of data from a computer database comprising a computer comprising a database accessible by the computer and a user interface in communication with the computer, a plurality of topic interfaces executing on the computer, the topic interfaces being displayed on the user interface to facilitate a user's entry and retrieval of database data pertaining to a particular topic, a plurality of forms associated with each topic interface executing on the computer, the forms structuring database data pertaining to the topic interface topic for display on the user interface, the forms being user selectable by using a first user selectable connection presented on the topic interface and a sponsor module executing on the computer, the sponsor module providing sponsor data about at least one sponsor of the forms and topic interface, the sponsor module presented on the forms and topic interface as a second user selectable connection.

### FIELD OF THE INVENTION

The present invention relates to a system for facilitating the management of data in a database, and more particularly to such a system which provides for the data in a database to be structured in a predefined format that contains connections to other relevant data.

### BACKGROUND OF THE INVENTION

The proliferation of data in today's society has created numerous unintended disadvantages for the data user because data producers and data suppliers can easily generate a vast quantity of data for a user with little effort on their part. Consequently, the data user is now tasked with having to manage vast quantities of data with minimal help from data producers and suppliers. Accordingly, there are at least two commonly cited disadvantages that data users face when dealing with data overload.

First, the most commonly cited disadvantage created by data overload is the inability of the data user to find useful or needed data. For example, a modern computer possesses the ability to file and store a very large quantity of data and as a result, the data user has to search this large store of data for the desired data. There are a number of tools available to the data user to facilitate the searching task such as system search engines and indexes.

However, the problem with search engines and indexes is that they are limited by how close the desired data reflects the index or search terms, e.g. looking for a particular term when the synonym of the term is used by the index and search engine. Thus, the problem becomes one of access because data is not useful unless the data can be successfully utilized by a user. It is therefore important to know where and how to find the data that one needs to know quickly and efficiently.

And secondly, another commonly cited disadvantage created by data overload is that the needed data is discrete and fragmentary. For instance, medical data such as a list of the names of drugs taken by a person would not be as useful as also knowing what the recommended dosage was, what pharmacy the drugs came from, who was the prescribing physician and what instructions for taking the drug where given. Thus, it is important that data is delivered in a context that provides relational association between the desired data and related relevant data.

Consequently, what is needed is a system to provide a better way to input, structure, associate and retrieve data for a database because data is generally only valuable if it is quickly and efficiently accessed. What is also needed is a system that will integrate discrete and fragmentary data into an associated whole thereby making the discrete and fragmentary data relevant in a presented context. In addition, the associating of the discrete and fragmentary data should make the data more navigable and easier to interpret. Also, the system should reduce duplicate effort in the initial entry of the data into the system.

### SUMMARY OF THE INVENTION

Accordingly, it is an object of the present invention to provide a system to facilitate users in structuring unstructured data.

Another object of the present invention is to provide a system that presents data in a format that format provides relational associations data.

A further object of the present invention is provide a system that will create relational associations between displayed data and other relevant data in the database, the relational associations providing an easy path to access the other relevant data.

Still another object of the present invention is to provide a system of a better way to input, structure, associate and retrieve data for a database because data is generally only valuable if it is quickly and efficiently accessed.

Still yet another object of the present invention is to provide a system that will integrate discrete and fragmentary data into grouped relational associations thereby making the discrete and fragmentary data relevant in a presented context as well as making the data more navigable and easier to interpret.

And still yet another object of the present invention is to provide a system that will reduce duplicate effort in the entry of the data into the system.

And yet a further object of the present invention is to provide a system that will promote a sponsor to the user according to the topic interface and forms being used by the user.

Yet a further object of the present invention is to provide a method to facilitate a sponsor to sub-brand the system to affiliates.

And still yet another object of the present invention is to provide a system that will receive data from a sponsor to populate data fields in a form with relevant form data and export form data to a sponsor to facilitate the obtaining of services from the sponsor.

These and other objects of the present invention are achieved by provision of a system to facilitate the access of data from a computer database comprising a computer comprising a database accessible by the computer and a user interface in communication with the computer, a plurality of topic interfaces executing on the computer, the topic interfaces being displayed on the user interface to facilitate a user's entry and retrieval of database data pertaining to a particular topic, a plurality of forms associated with each topic interface executing on the computer, the forms structuring database data pertaining to the topic interface topic for display on the user interface, the forms being user selectable by using a first user selectable connection presented on the topic interface and a sponsor module executing on the computer, the sponsor module providing sponsor data about at least one sponsor of the forms and topic interface, the sponsor module presented on the forms and topic interface as a second user selectable connection.

The system preferably further comprising a network connection in communication with the computer, the network connection connecting a user to the sponsor via the second user selectable connection, a third user selectable connection in communication with the computer, the third user selectable connection displayed on a first form to connect the first form to a second form contained on another topic interface, a fourth user selectable connection in communication with the computer, the fourth user selectable connection displayed on a form to send an electronic message to an entity that is relevant to the data of the form, a scheduling module in communication with the computer, the scheduling module delivers user notification messages when a scheduled time has occurred, an interaction module in communications with the computer, the interaction module receiving data from a sponsor to populate data fields in a form with relevant form data and exporting form data to a sponsor to facilitate the obtaining of services from the sponsor and wherein the system populates data fields that are common data fields in both the topic interfaces and the forms with a single entry.

The method preferably further comprising the steps of providing a sponsored database for the storage of personal information for at least one user, providing a plurality of forms for organizing the personal information according to the personal information topic, each form displaying the sponsors data, distributing the sponsored database to clients and prospective clients of the sponsored database sponsor and providing a user selectable connection on each form in the sponsored database, the user selectable connection connecting the clients and prospective clients of the sponsored database to the sponsor.

The method also comprising the steps of exporting client data to a sponsor to facilitate the obtaining of services from the sponsor, importing sponsor data to the client from a sponsor to facilitate the obtaining of services from the sponsor, providing a scheduling module that delivers a user notification message when a scheduled time has occurred, receiving data from a sponsor to populate data fields in a form with relevant form data, printing the sponsors data on each page of the printout from the forms. The method further including connecting to the sponsor by a network connection, the network connection activated by a user selecting the user selectable connection, the scheduled time is scheduled by the sponsor, the sponsor data can be changed without having to rebuild the sponsored database and the sponsor is an affiliate of another sponsor.

Other objects of the present invention are achieved by provision of software executing on a computer to facilitate the access of data from a computer database based on the use of a plurality of structured forms, the method comprising the steps of providing a plurality of topic interfaces for the computer database data, each topic interface representing select computer database data pertaining to the topic interface topic, structuring topic interface data into a plurality of forms, the forms selectable by a user using a first user selectable connection displayed on the topic interface, providing a sponsor module that provides sponsor data about at least one sponsor of the form and topic interface, the sponsor module presented on the form and topic interface as a second user selectable connection and selecting a form to access the topic interface data in a structured arrangement.

The method preferably further comprising the steps of populating data fields that are common data fields in both the topic interfaces and the forms with a single entry, exporting form data to a sponsor to facilitate the obtaining of services from the sponsor, connecting to the sponsor via a network connection, the network connection activated by a user selecting the second user selectable connection, providing a third user selectable connection displayed on a first form to connect the first form to a second form contained on another topic interface, providing a fourth user selectable connection displayed on a form to send an electronic message to an entity that is relevant to the data of the form, providing a scheduling module that delivers user notification messages when a scheduled time has occurred, and receiving data from a sponsor to populate data fields in a form with relevant form data.

Preferably, the system also includes a computer-readable medium containing a program which executes the following procedure by providing a plurality of topic interfaces for the computer database data, each topic interface representing select computer database data pertaining to the topic interface topic, structuring topic interface data into a plurality of forms, the forms selectable by a user using a first user selectable connection displayed on the topic interface, providing a sponsor module that provides sponsor data about at least one sponsor of the form and topic interface, the sponsor module presented on the form and topic interface as a second user selectable connection and selecting a form to access the topic interface data in a structured arrangement.

The computer-readable medium also preferably providing for populating data fields that are common data fields in both the topic interfaces and the forms with a single entry, exporting form data to a sponsor to facilitate the obtaining of services from the sponsor, connecting to the sponsor via a network connection, the network connection activated by a user selecting the second user selectable connection, providing a third user selectable connection displayed on a first form to connect the first form to a second form contained on another topic interface, providing a scheduling module that delivers user notification messages when a scheduled time has occurred, providing a fourth user selectable connection displayed on a form to send an electronic message to an entity that is relevant to the data of the form, and receiving data from a sponsor to populate data fields in a form with relevant form data.

The invention and its particular features and advantages will become more apparent from the following detailed description considered with reference to the accompanying drawings.

### BRIEF DESCRIPTION OF THE DRAWINGS

FIG. 1 is a block diagram of a system for facilitating the management of database data in accordance with the present invention;

FIG. 2 is a block diagram of the connections within the system which facilitates the management of database data of FIG. 1;

FIG. 3 is an exemplary screen shot of a topic interface and accompanying form as produced by the system of FIG. 1;

FIG. 4 is an exemplary screen shot of a form as produced by the system of FIG. 1;

FIG. 5 is an exemplary screen shot of a form as produced by the system of FIG. 1;

FIG. 6 is an exemplary screen shot of a form as produced by the system of FIG. 1;

FIG. 7 is an exemplary screen shot of a form as produced by the system of FIG. 1;

FIG. 8 is an exemplary screen shot of a topic interface, form, report and CD decoration as produced by the system of FIG. 1; and

FIG. 9 is an exemplary screen shot of a form with a spreadsheet link activated as produced by the system of FIG. 1.

### DETAILED DESCRIPTION OF THE DRAWINGS

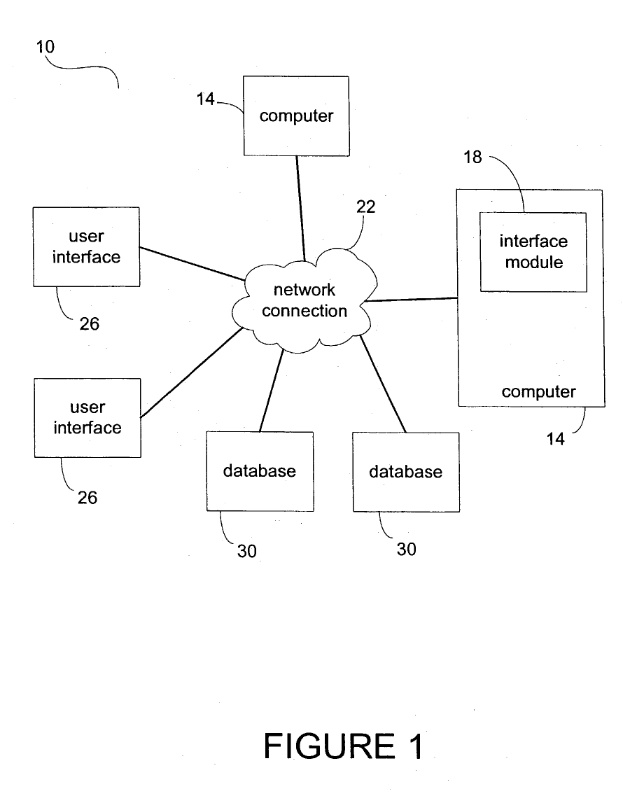

System 10 is a system for facilitating user retrieval of data from at least one database 30 in accordance with the embodiment of the invention shown in FIG. 1. System 10 structures and associates database data for a user based upon the use of topic interfaces and associated forms generated by interface module 18 that runs on computer 14. System 10 also includes at least one user interface 26 which is used by a user to access system 10 although multiple user can also utilize multiple profiles on system 10.

System 10 can communicate with multiple computers 14 and may have multiple user interfaces 26 as may be found in a networked system such as a LAN, Ethernet, intranet, internet or the like. System 10 components are connected by network connection 22 which can be a wired, wireless or combination of wired and wireless connections, e.g. parallel cable, serial cable, coaxial cable, twisted wire pair, USB cable, infrared link, radio frequency link, microwave link, satellite link and the like.

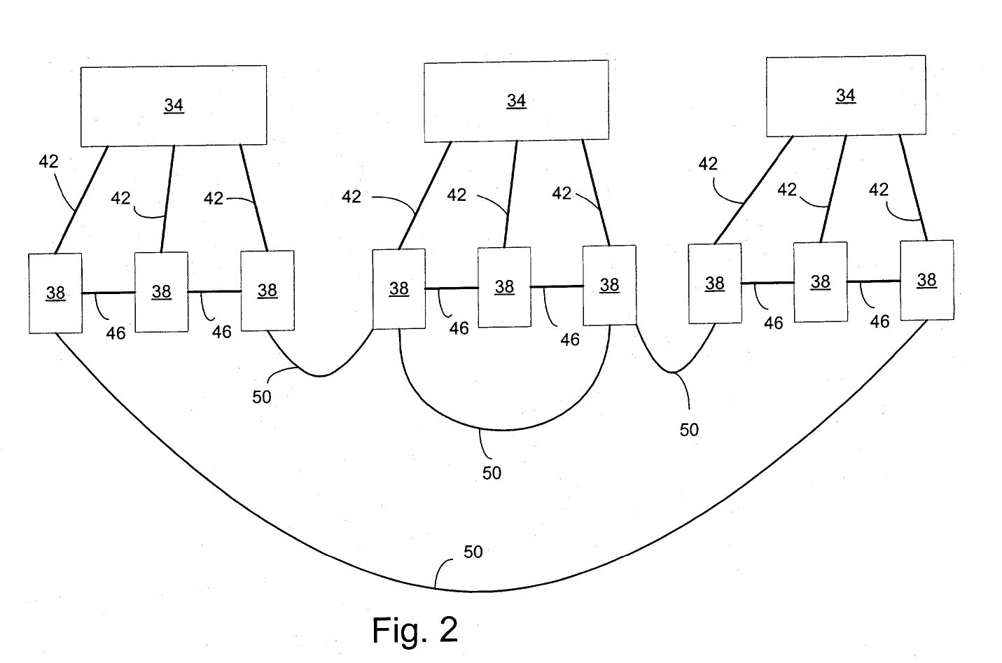

Referring now to FIG. 2, a user selects a topic interface 34 through user interface 26 according to the topic of the data desired by the user, e.g. property, banking and brokerage, important people, other financial and the like. Since, data is generally fragmentary and discrete, topic interface 34 is the first step of putting the fragmentary and discrete data into a grouped association whereby the data gains relational context by the association.

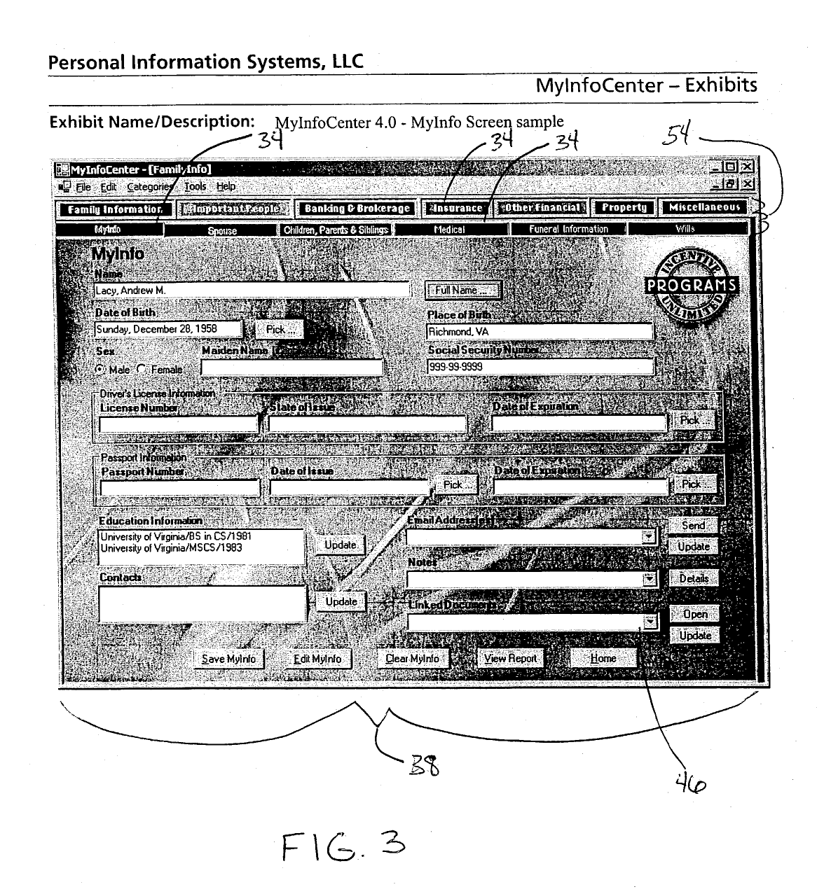

Topic interface 34 is then displayed on user interface 26 and shows forms 38 that are topic interface 34 topic specific and connected by connection 42. For example, referring to FIG. 3, topic interface 34 for Myinfo is opened by connection 42 while other topic interfaces 34 such as medical and insurance are displayed in topic interface toolbar 54.

Within the Myinfo topic interface 34, form 38 groups data about a particular topic by relational association which gives context to the discrete and fragmentary data. This additional relational context allows a user to search by concept rather than a keyword to find a particular piece of data. For example, a user trying to find a particular piece of data about their medical status can start the search by looking for the general category of medical rather than trying to guess what keyword the search engine for their file system will need to locate a particular piece of data.

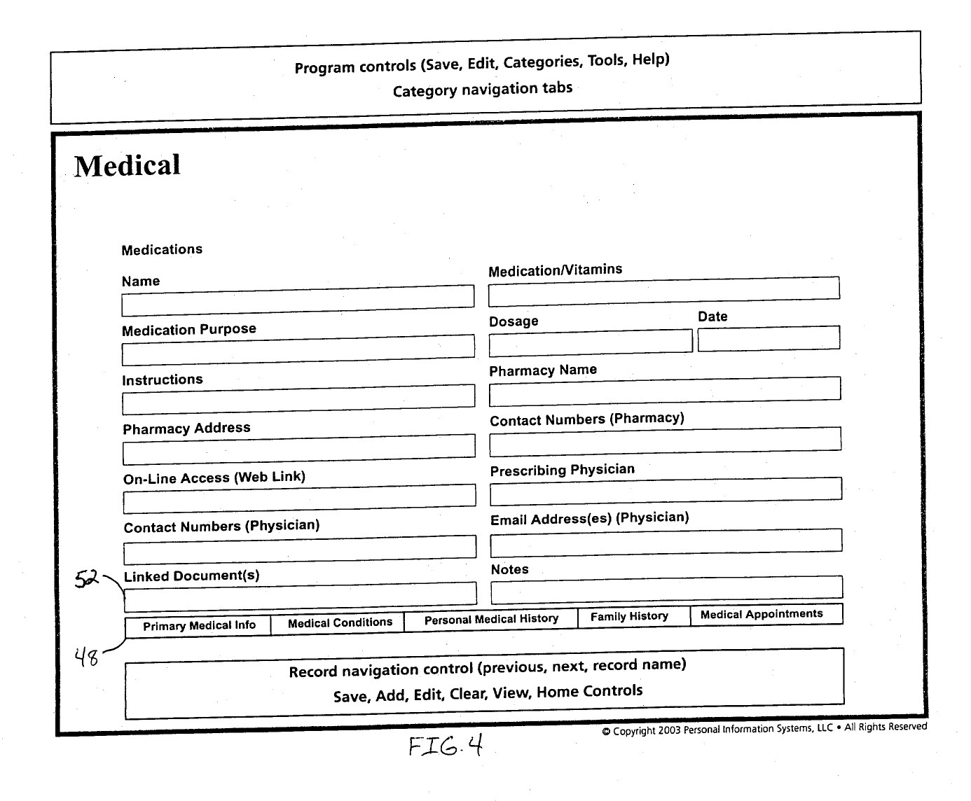

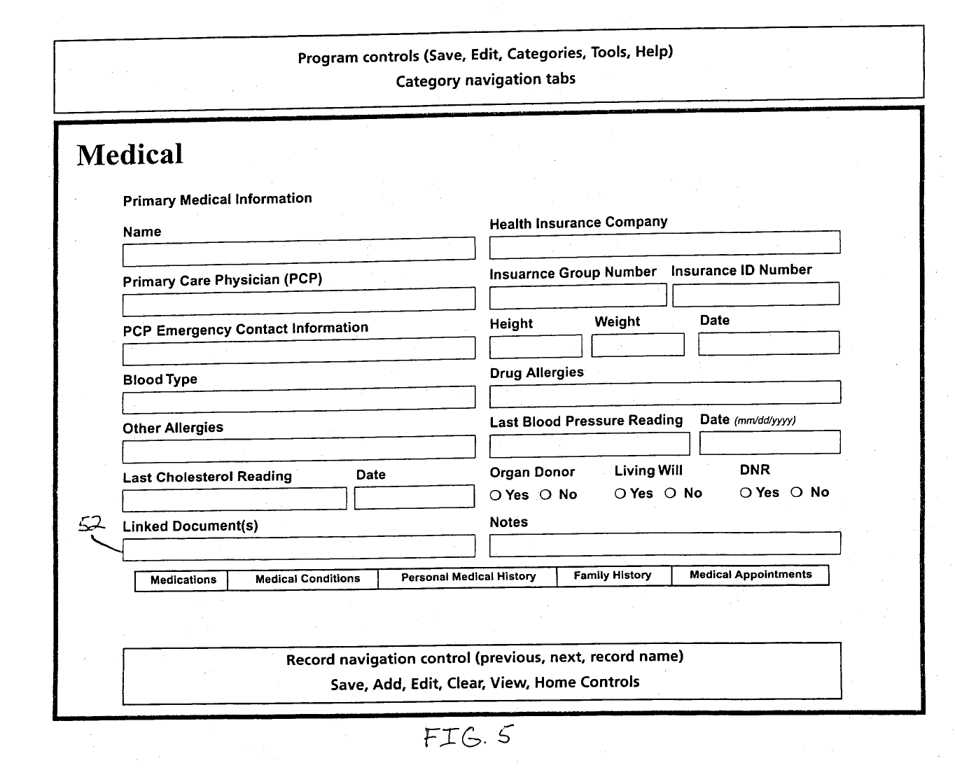

For instance, the user might be trying to find out about their medications. Once they select the medical topic interface 34, the medications form 38 is displayed and from there the user can easily locate the necessary data, FIG. 4. Carrying the medications example further, suppose the user wanted to know if the medication is covered under their health insurance policy. The user can go to a linked document, primary medical info 48, via connection 46 and find data that will help them answer that question on FIG. 5.

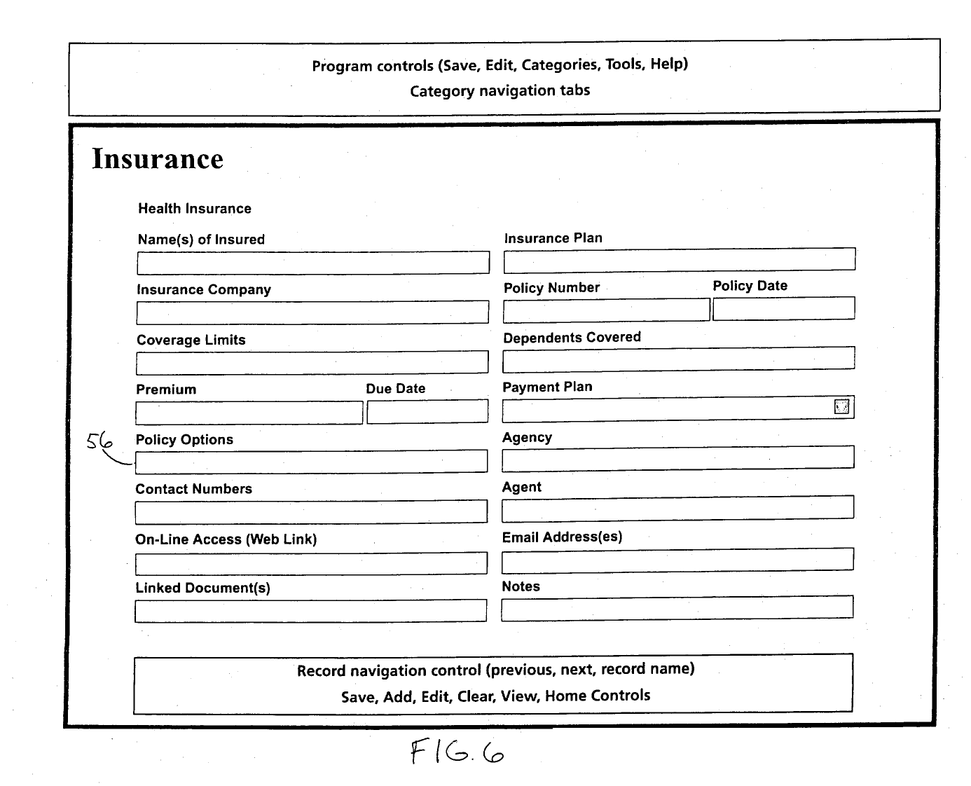

Also, a user can connect from one form 38 in one topic interface 34 to another form 38 in another topic interface 34 via connection 50 (FIG. 2). Again, referring to the medications example, the user could have used a connection or linked document 52 to connect via connection 50 to health insurance topic interface 34 where they could find policy options 56 in FIG. 6. The ability to provide a user multiple paths to the same piece of data is important because discrete and fragmentary data can have multiple relationships with other data.

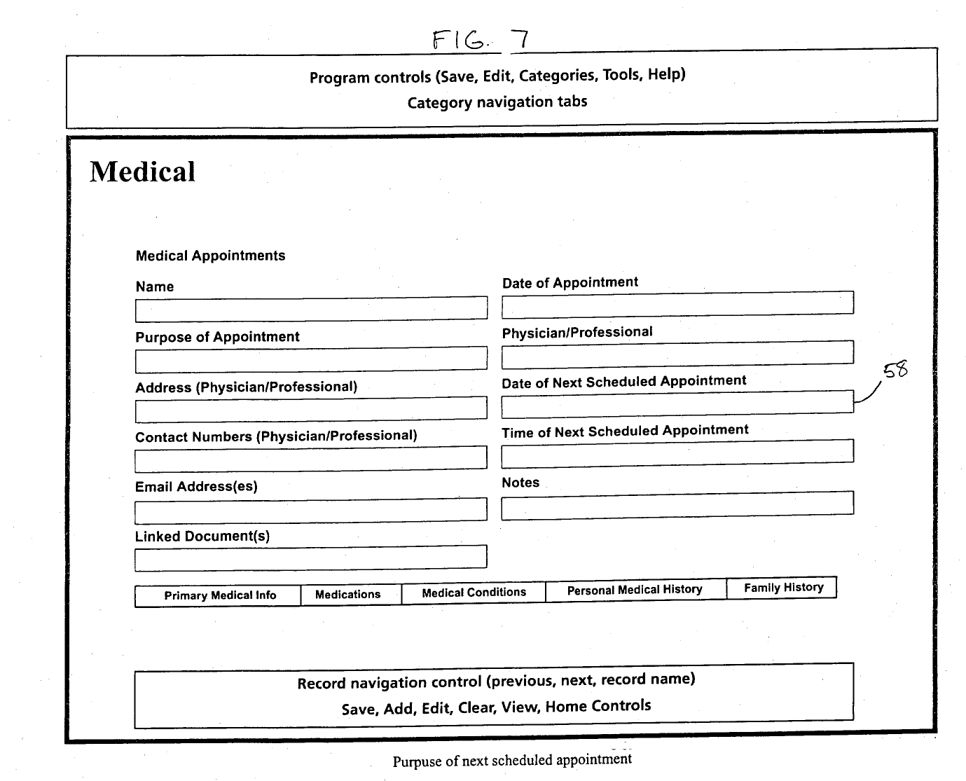

Referring now to FIG. 7, system 10 also includes an alert function 58 by which the system sends a message to the user to remind the user of a scheduled appointment. In addition, system 10 provides a pop-up form that will appear on application start-up that puts up a reminder list about upcoming important dates and events. This pop-up will have a sorted list of upcoming items with the next occurring item listed first and the farthest away item last. The pop-up will separate items that will occur within specific timeframes, e.g. today, the next seven days, the next month and the like. The user has the option on the pop-up screen of turning off the warning on an individual item basis or turning off the feature altogether. For individual items that are recurring events only that occurrence is turned off. In order to turn-off an item completely or not have it show up as a reminder at all, the checkbox on the item itself that excludes it from the pop-up tickler would need to be used.

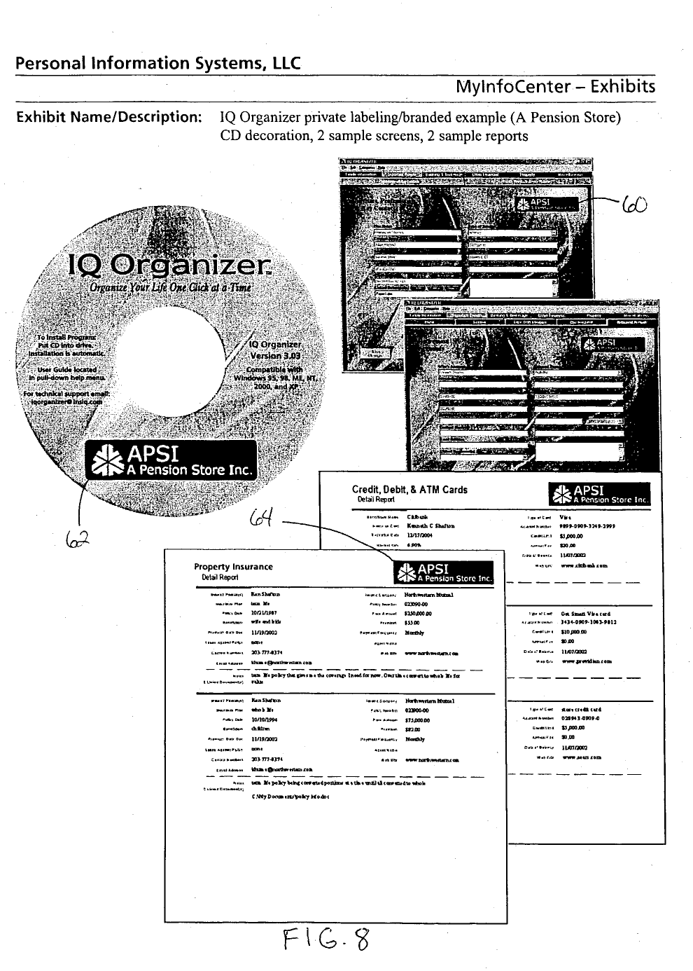

One application of system 10 is as a promotional tool by which the system is distributed free of charge by a sponsor of the product as shown in FIG. 8. The sponsor will be able to put their logo on splash plate 62, the background images 60 and images on the report pages 64 and the placement of the logo will not require the need for programming and rebuilding the application. System 10 can also be sub-branded by a sponsor distributing the system for different affiliates. System 10's ability to not have to be reprogrammed and/or rebuilt for each sponsor makes the system flexible and cost efficient as a promotional tool because multiple sponsors can distribute the product with minimal labor investment.

A further embodiment of the invention will also provide a connection to the sponsor thereby permitting the user to go from a sponsored form 38 to a communication link with the sponsor. The sponsor connection will provide import/export capabilities for the database between the sponsor and the user. The import/export capabilities provides for data external to the system, e.g. a sponsor, sends data to the user to populate fields that pertain to the service provided by the sponsor to the user. For example, a bank sponsor can send the user's bank statement to the banking topic interface 34 to fill in relevant bank forms 38. In response to such a data import, the user can export data back to the sponsor through system 10.

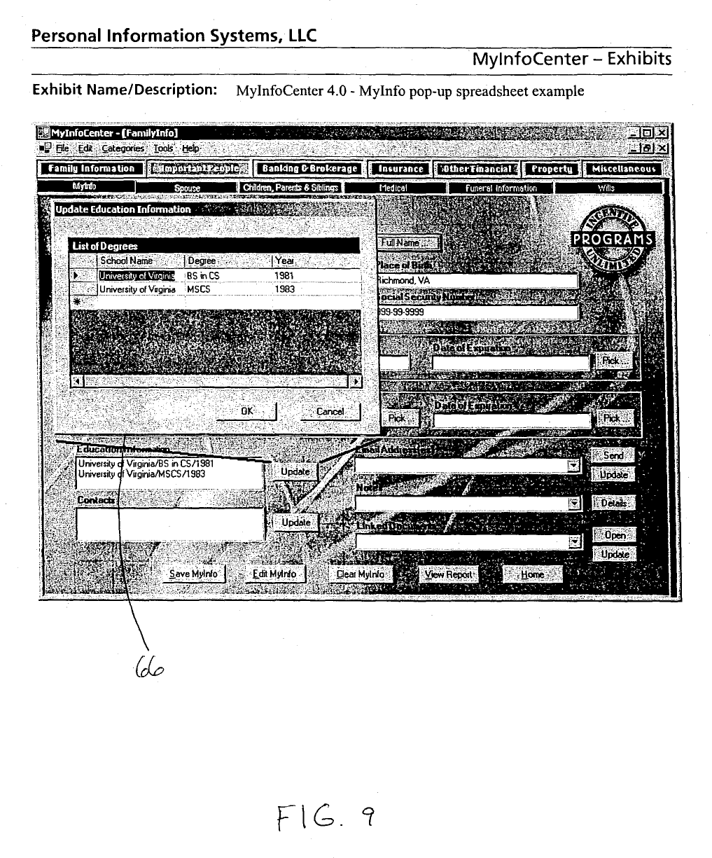

FIG. 9 is an example of how system 10 incorporates a spread sheet 66 into forms 38. The advantage of spread sheet 66 is that it provides access through one topic interface 34 to data from multiple applications thereby allowing a user to navigate for all their data in one database through multiple paths to the same data.

Also, system 10 eliminates duplicated data by structuring lookup tables using a relational model. Information is to be regularized so that items that are similar are stored in same way. For instance, people whether family members, friends, contacts, or professionals should be stored in the same table structure and referenced from the tables to which they are related.

Although the invention has been described with reference to a particular arrangement of parts, features and the like, these are not intended to exhaust all possible arrangements or features, and indeed many other modifications and variations will be ascertainable to those skill in the art.

What is claimed is:

1. A method to promote a sponsored database sponsor, the method comprising the steps of:
providing a sponsored database for the storage of personal information for at least one user;
providing a plurality of forms for organizing the personal information according to the personal information topic, each form displaying the sponsors data;
distributing the sponsored database to clients and prospective clients of the sponsored database sponsor; and
providing a user selectable connection on each form in the sponsored database, the user selectable connection connecting the clients and prospective clients of the sponsored database to the sponsor.

2. The method of claim 1 wherein the connecting to the sponsor is by a network connection, the network connection activated by a user selecting the user selectable connection.

3. The method of claim 2 further comprising the step of:
exporting client data to a sponsor to facilitate the obtaining of services from the sponsor.

4. The method of claim 2 further comprising the step of:
importing sponsor data to the client from a sponsor to facilitate the obtaining of services from the sponsor.

5. The method of claim 1 further comprising the step of:
providing a scheduling module that delivers a user notification message when a scheduled time has occurred.

6. The method of claim 5 wherein the scheduled time is scheduled by the sponsor.

7. The method of claim 2 further comprising the step of:
receiving data from a sponsor to populate data fields in a form with relevant form data.

8. The method of claim 1 further comprising the step of:
printing the sponsors data on each page of the printout from the forms.

9. The method of claim 1 wherein the sponsor data can be changed without having to rebuild the sponsored database.

10. A method to facilitate the access of data from a computer database based on the use of a plurality of structured forms, the method comprising the steps of:
providing a plurality of topic interfaces for the computer database data, each topic interface representing select computer database data pertaining to the topic interface topic;
structuring topic interface data into a plurality of forms, the forms selectable by a user using a first user selectable connection displayed on the topic interface;
providing a sponsor module that provides sponsor data about at least one sponsor of the form and topic interface, the sponsor module presented on the form and topic interface as a second user selectable connection; and
selecting a form to access the topic interface data in a structured arrangement.

11. The method of claim 10 further comprising the step of:
populating data fields that are common data fields in both the topic interfaces and the forms with a single entry.

12. The method of claim 10 further comprising the step of:
exporting form data to a sponsor to facilitate the obtaining of services from the sponsor.

13. The method of claim 10 further comprising the step of:
connecting to the sponsor via a network connection, the network connection activated by a user selecting the second user selectable connection.

14. The method of claim 10 further comprising the step of:
providing a third user selectable connection displayed on a first form to connect the first form to a second form contained on another topic interface.

15. The method of claim 13 further comprising the step of:
providing a fourth user selectable connection displayed on a form to send an electronic message to an entity that is relevant to the data of the form.

16. The method of claim 10 further comprising the step of:
providing a scheduling module that delivers user notification messages when a scheduled time has occurred.

17. The method of claim 13 further comprising the step of:
receiving data from a sponsor to populate data fields in a form with relevant form data.

18. A system to facilitate the access of data from a computer database, comprising:
a computer comprising a database accessible by the computer and a user interface in communication with the computer;
a plurality of topic interfaces executing on the computer, the topic interfaces being displayed on the user interface to facilitate a user's entry and retrieval of database data pertaining to a particular topic;
a plurality of forms associated with each topic interface executing on the computer, the forms structuring database data pertaining to the topic interface topic for display on the user interface, the forms being user selectable by using a first user selectable connection presented on the topic interface; and
a sponsor module executing on the computer, the sponsor module providing sponsor data about at least one sponsor of the forms and topic interface, the sponsor module presented on the forms and topic interface as a second user selectable connection.

19. The system of claim 18 further comprising:
a network connection in communication with the computer, the network connection connecting a user to the sponsor via the second user selectable connection.

20. The system of claim 18 further comprising:
a third user selectable connection in communication with the computer, the third user selectable connection displayed on a first form to connect the first form to a second form contained on another topic interface.

21. The system of claim 19 further comprising:
a fourth user selectable connection in communication with the computer, the fourth user selectable connection displayed on a form to send an electronic message to an entity that is relevant to the data of the form.

22. The system of claim 18 further comprising:
a scheduling module in communication with the computer, the scheduling module delivers user notification messages when a scheduled time has occurred.

23. The system of claim 19 further comprising:
an interaction module in communications with the computer, the interaction module receiving data from a sponsor to populate data fields in a form with relevant form data and exporting form data to a sponsor to facilitate the obtaining of services from the sponsor.

24. The system of claim 18 wherein the system populates data fields that are common data fields in both the topic interfaces and the forms with a single entry.

25. A computer-readable medium containing a program which executes the following procedure:
providing a plurality of topic interfaces for the computer database data, each topic interface representing select computer database data pertaining to the topic interface topic;
structuring topic interface data into a plurality of forms, the forms selectable by a user using a first user selectable connection displayed on the topic interface;
providing a sponsor module that provides sponsor data about at least one sponsor of the form and topic interface, the sponsor module presented on the form and topic interface as a second user selectable connection; and
selecting a form to access the topic interface data in a structured arrangement.

26. The method of claim 1 wherein the sponsor is an affiliate of another sponsor.
